(19) United States
(12) Patent Application Publication
(10) Pub. No.: US 2026/0227237 A1
(43) Pub. Date: Aug. 6, 2026

(54) SPECTROMETER AND METHOD OF MAKING A SPECTROMETER

(71) Applicant: University of Southampton, Southampton, Hampshire (GB)

(72) Inventors: Martynas BERESNA, Southampton, Hampshire (GB); Christopher HOLMES, Southampton, Hampshire (GB); Przemyslaw FALAK, Southampton, Hampshire (GB)

(73) Assignee: University of Southampton, Southampton, Hampshire (GB)

(21) Appl. No.: 19/150,887

(22) PCT Filed: Jan. 9, 2024
(86) PCT No.: PCT/GB2024/050037

§ 371 Date: Jul. 24, 2025

(30) Foreign Application Priority Data
Jan. 25, 2023 (GB) 2301076.2

(51) Int. Cl. G01J 3/18; G01J 3/02; G01J 3/28; G01L 1/24

(52) U.S. Cl. CPC G01J 3/1895; G01J 3/0218; G01J 3/0291; G01J 3/2803; G01L 1/246

(57) ABSTRACT

A spectrometer comprises a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length; an input optical fibre optically coupled to the input face to transmit incident light into the flat optical fibre along the propagation direction; and a scattering structure within the flat optical fibre configured to receive and scatter the incident light to create a speckle pattern via interference of the scattered incident light, a component of the speckle pattern being emitted for detection from the flat optical fibre through the output face along a direction orthogonal to the propagation direction.

### BACKGROUND OF THE INVENTION

The present invention relates to a spectrometer and a method for performing spectrometry.

A spectrometer, or spectrum analyzer, is an optical detector configured to detect or measure the spectral characteristics of light incident on the detector, in other words to determine the wavelength or spectral profile of the incident light, or interrogate an optical device that produces an output of variable wavelength. Historically, spectrometers have been bulky, heavy and costly, requiring a dispersive element such as a prism or grating for angularly separating components of the light of different wavelengths and directing the spectrally dispersed light onto a detector array. The spectral resolution depends on the spacing by which the components are separated at the detector, and is improved by a longer path length from the dispersive element to the detector, resulting in a large device or requiring many optical components to fold the optical path. There tends to be trade-off between resolution and device size/cost.

More recently, spectrometers have been developed that detect optical speckle patterns. These can be generated when incident light is directed onto a scattering structure or scattering medium. The scattering structure comprises a plurality of scattering points, centres or elements with which the light interacts. Different portions of the light follow different pathways through the scattering medium so that the light acquires a phase distribution allowing constructive and destructive interference between the different portions so that the light leaving the scattering medium has an intricate spatial pattern of varying intensity, known as speckle. The interference which occurs is dependent on the wavelength of the light, so that for a fixed scattering structure, every wavelength or wavelength spectrum of the incident light creates a different speckle pattern. The mapping is unique in that each wavelength generates one and only one speckle pattern, and each speckle pattern arises from one and only one wavelength. Hence, if a calibration set of speckle patterns is detected and collected for a range of known incident wavelengths interacting with the scattering medium, light of an unknown wavelength made incident on the scattering medium can have its spectral characteristic identified, determined or reconstructed by matching or correlating its speckle pattern with a pattern in the calibration set.

A variety of arrangements have been proposed to implement speckle-based spectrometry. Examples include an array of randomly or pseudo-randomly positioned scattering centres such as holes or voids can be formed in or on a solid medium [1], such as by writing with pulsed laser light to form a two-dimensional array on a photonic chip [2]. A laser-written three-dimensional array allows the optical path to be folded multiple times within the scattering structure, thereby enhancing unique speckle generation for improved resolution [3]. Multimode optical fibre may alternatively be used to generate speckle patterns [4, 5]. Light input into the optical fibre divides into multiple optical modes which interfere with one another to create speckle patterns in the light output by the optical fibre. Such devices tend to offer increased compactness compared to dispersive devices, with good resolution, typically on the nanometre to picometre scale. However, stability of reported devices tends to be poor, lasting only a few minutes or hours, which is impractical for a commercial spectrometer and for applications in extreme or fluctuating environments. Instability of the speckle-generating medium and/or the optical path to the medium and from the medium to the optical detector will disrupt the unique mapping between wavelength and speckle pattern, reducing spectral measurement accuracy and resolution.

Accordingly, approaches that aim to improve the design and performance of optical speckle-based spectrometry are of interest.

### SUMMARY OF THE INVENTION

Aspects and embodiments are set out in the appended claims.

According to a first aspect of certain embodiments described herein, there is provided a spectrometer comprising: a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length; an input optical fibre optically coupled to the input face to transmit incident light into the flat optical fibre along the propagation direction; and a scattering structure within the flat optical fibre configured to receive and scatter the incident light to create a speckle pattern via interference of the scattered incident light, a component of the speckle pattern being emitted for detection from the flat optical fibre through the output face along a direction orthogonal to the propagation direction.

According to a second aspect of certain embodiments described herein, there is provided a sensor system comprising: a spectrometer according to the first aspect; and at least one sensor configured to generate an optical output with a variable spectral characteristic to be transmitted as the incident light into the flat optical fibre by the input optical fibre.

According to a third aspect of certain embodiments described herein, there is provided an item formed from a laminated material comprising two or more ply layers, and comprising: a sensor system according to the second aspect, wherein the at least one sensor is embedded between adjacent ply layers of the laminated material to operate as a sensor or sensors for measuring strain in the component.

According to a fourth aspect of certain embodiments described herein, there is provided a component for a spectrometer comprising: a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length, the input face configured to be coupled to an input optical fibre for transmitting incident light into the flat optical fibre along a propagation direction; and a scattering structure within the flat optical fibre configured to receive and scatter the incident light to create a speckle pattern via interference of the scattered incident light, a component of the speckle pattern being emitted for detection from the flat optical fibre through the output face along a direction orthogonal to the propagation direction.

According to a fifth aspect of certain embodiments described herein, there is provided a method of making a spectrometer, the method comprising: obtaining or fabricating a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length; forming a scattering structure within the flat optical fibre to receive and scatter incident light to create a speckle pattern via interference of the scattered incident light, a component of the speckle pattern being emitted from the flat optical fibre through the output face along a direction orthogonal to the propagation direction; and coupling an input optical fibre to the input face to transmit the incident light into the flat optical fibre along the propagation direction.

These and further aspects of certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, spectrometers and methods of spectrometry may be provided in accordance with approaches described herein which includes any one or more of the various features described below as appropriate.

### BRIEF DESCRIPTION OF THE DRAWINGS

For a better understanding of the invention and to show how the same may be carried into effect reference is now made by way of example to the accompanying drawings in which:

FIG. 1 shows a simplified schematic perspective view of an example portion of flat optical fibre suitable for use in a spectrometer according to the present disclosure;

FIG. 2 shows a simplified schematic plan view of an example spectrometer according to an aspect of the present disclosure;

FIG. 3 shows a simplified schematic side view of a further example spectrometer according to an aspect of the present disclosure;

FIG. 4 shows a simplified schematic representation of an example sensor system according to an aspect of the present disclosure;

FIG. 5 shows a simplified schematic representation of a further example sensor according to an aspect of the present disclosure;

FIG. 6 shows a graph of results of strain measurements obtained using a sensor interrogated with an example spectrometer according to an aspect of the present disclosure; and

FIG. 7 shows a flow chart of an example method of making a spectrometer according to an aspect of the present disclosure.

### DETAILED DESCRIPTION

Aspects and features of certain examples and embodiments are discussed / described herein. Some aspects and features of certain examples and embodiments may be implemented conventionally and these are not discussed/described in detail in the interests of brevity. It will thus be appreciated that aspects and features of devices and methods discussed herein which are not described in detail may be implemented in accordance with any conventional techniques for implementing such aspects and features.

A spectrometer is proposed which uses scattering of incoming light to generate speckle patterns, which, owing to the one-to-one unique relationship between wavelength and the intensity distribution across a speckle pattern, can be used to deduce or identify the wavelength of the incoming light. More broadly, the wavelength can be understood as the spectral characteristic of the light, where the light may have a spectrum with a narrow spectral bandwidth comprising essentially a single wavelength, or a broader spectral bandwidth covering many wavelengths which may have the same amplitude or different amplitudes, or two or more narrow peaks at different wavelengths. Variation of the spectral characteristic can include changes in wavelength, amplitude or both. According to the disclosure, the scattering is implemented by a scattering structure (comprising a plurality of randomly or pseudo-randomly distributed scattering points or centres) within a portion of flat optical fibre, the scattering structure being defined within the material of the flat optical fibre. The material is transparent to the incoming light and is thereby selected to have a window of transparency spanning the anticipated range of wavelengths of light for which the spectrometer is intended for use. The material may be glass, for example silica, fused silica, with or without dopants, although other types of glass, and other transparent materials such as polymers are not excluded.

A flat optical fibre is an optical structure configured for the waveguiding of light along a length direction (optical propagation direction) of the flat optical fibre, in common with a conventional optical fibre of circular cross-section. Flat optical fibre differs from circular optical fibre in that its transverse cross-section, in a plane orthogonal to the propagation direction, is substantially rectangular (albeit with optionally rounded corners), in that the flat optical fibre has a width and a thickness both orthogonal to the length, with the width typically being several or many times greater than the thickness. For example, the width may be at least three times greater than the thickness, or at least five times or at least ten times greater. For the present application, the thickness may be less than 1 mm, and in some examples may be less than 500 μm. The width and the thickness therefore bound and define the end faces of the flat optical fibre. For the present application, one of the end faces is designated as an input face, in that it receives incoming, incident light along the propagation direction, to be scattered by the scattering structure within the flat optical fibre. For ease of the current description, the faces of the flat optical fibre bounded by the length and the width are designated as side faces, and the faces bounded by the length and the thickness are designated as edge faces. Owing to the width exceeding the thickness, the side faces have a greater surface area than the edge faces.

The waveguiding capability of flat optical fibre can be, at least in part, provided by total internal reflection of propagating light at the material-air interface at the surfaces of the flat optical fibre, in particular at the side faces, where the forward propagation of light generally along the propagation direction is facilitated by the small size of the fibre thickness in order to keep propagating light confined within the fibre. Reflection at the material-air interface can be sufficient to provide all the required waveguiding function, so that a flat optical fibre may not have a core, in other words, it has a uniform refractive index profile across the transverse plane orthogonal to the propagation direction. In other examples, a flat optical fibre may have a core, provided by a region of higher refractive index of the fibre material typically located centrally in the transverse plane, in the same manner as conventional circular solid-core optical fibre, where internal reflection occurs at the boundary between refractive indices. The refractive index profile may have a step change or a more complex, for example, tapering change between the higher index region of the core and the adjacent lower index region (cladding, in the nomenclature of circular optical fibres), similar to circular optical fibres. The refractive index may vary along both the width and the thickness directions, or along the width direction only with the optical confinement in the thickness direction being provided at the material-air interface. The flat optical fibre may be configured (by its dimensions and its refractive index structure) for waveguiding of a single optical mode (single mode fibre), or for two or more (multiple) optical modes (multi-mode fibre).

Flat optical fibre can be fabricated in the same manner as is well-known for circular optical fibre, namely by providing a preform or cane having a same or similar cross-sectional structure as the required structure of the finished fibre but on a larger scale, heating an end portion of the preform in order to soften the material of the preform, and drawing the softened material down into a much smaller geometry (decreased width and thickness) to create the fibre, typically carried out in a fibre drawing tower. Flat optical fibre is therefore readily manufacturable using known techniques, to produce a planar glass substrate of appropriate dimensions for the scattering structure in a simple way, compared to, for example, machining of a bulk glass block.

To form a spectrometer from the flat optical fibre according to examples of the present disclosure, the required scattering centres forming a scattering structure are provided or formed within the material of a portion of flat optical fibre, with at least a part of the scattering structure located within the core in examples where the flat optical fibre has a core. The flat optical fibre can be thought of as a planar substrate with an internal scattering structure.

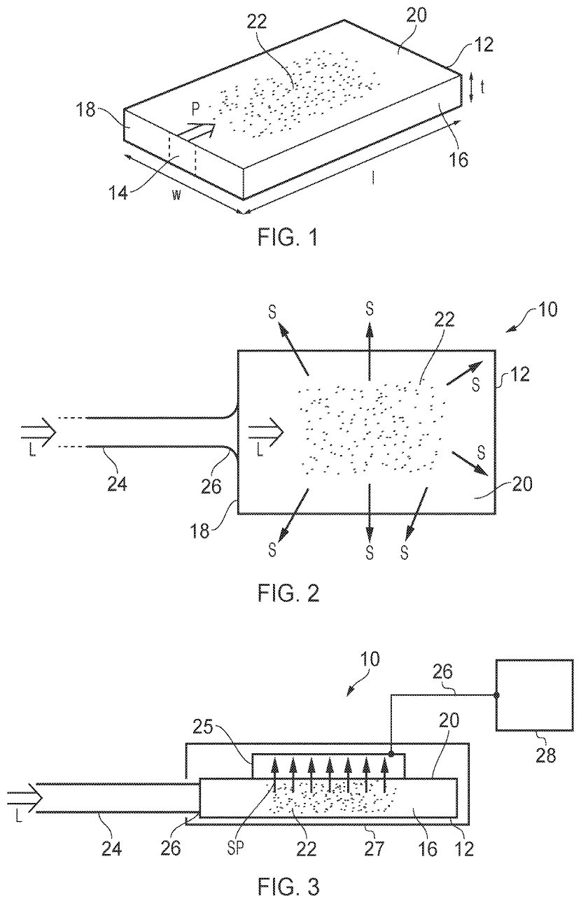

FIG. 1 shows a simplified schematic perspective view of an example portion of flat optical fibre configured for use in speckle-based spectrometry as proposed herein. The flat optical fibre is suitable as a component for a spectrometer. The flat optical fibre 12 has, as described above, a length I along a direction for which the flat optical fibre 12 is configured for waveguiding of light along a propagation direction P. The flat optical fibre 12 also has a width w and a thickness t less than the width in the transverse plane, orthogonal to the propagation direction. These dimensions define an end, input face 18 bounded by the width w and the thickness t, through which light to be measured can be transmitted into the flat optical fibre 12, a side face 20 bounded by the length I and the width w (and similarly on the lower face, not shown) and edges faces 16 bounded by the length I and the thickness t. In this example, the length I is the longest dimension, and the side faces 20 have the largest area. The flat optical fibre 12 optionally has a core 14 of higher refractive index. A scattering structure 22 is present within the flat optical fibre 12.

As will be discussed further below, sufficient scattering for high resolution spectral discrimination can be achieved from a relatively small volume of scattering centres, allowing the flat fibre to also be small, compared to known spectrometer designs. As noted above, the thickness t may be up to about 1 mm. As an example, a width w of about 10 mm is an achievable flat fibre width for such a thickness, so that the width is about ten times the thickness. Also as explained further below, the total scattering is not particularly dependent on the available distance for light to travel along the propagation direction, so the length I can also be small, for example also about 10 mm. This should be compared with the use of multimode optical fibre to generate speckle patterns, where fibre lengths of at least 2 cm and sometimes significantly longer are required to obtain a good resolution. Purely as an example, therefore, the flat optical fibre may have a length I in the range of 5 mm to 50 mm, a width w in the range of 0.15mm to 3 mm (150 μm to 3000 μm) and a thickness t in the range of 0.05 mm to 1 mm (50 μm to 1000 μm). Dimensions outside these ranges are not excluded, however.

The use of flat optical fibre as a medium for housing or hosting scattering centres to implement speckle-based spectrometry has a number of advantages, which enable high resolution in combination with a compact geometry and small size, and increased stability which gives consistent operation over time. In order to generate a speckle pattern it is necessary to make the light of interest be incident on the scattering structure, and placing the scattering structure within an optical fibre allows the incident light to be coupled in with low loss and high robustness. It is therefore proposed that, in order to form a spectrometer, an input optical fibre is optically coupled to an end face, being the input face, of a portion of flat optical fibre having an internal scattering structure. Light to be measured by the spectrometer is coupled into the input optical fibre and transmitted from the input optical fibre into the flat optical fibre along the propagation direction, in the conventional manner for coupled optical fibres, so as to be incident on the scattering structure. The input of light into a spectrometer via an input optical fibre is well-known for conventional spectrometers, but the use of optical fibre as the scattering medium allows physical coupling of the input fibre via a join with low optical loss in order to maximise transmission of the available input light. While any known method for optical coupling of optical fibres may be used to join an end face of the input optical fibre to input face of the flat optical fibre, such as butt coupling and mechanical splicing, very good performance can be obtained by fusion splicing of the two fibres. This is a known fibre coupling technique, in which the fibre end faces are closely aligned and heated in order to soften the glass at the fibre ends, and then pushed together so that the softened glass fuses together to form a permanent join, the two fibres becoming a unitary structure. In the present context, this is beneficial in that a stable mechanical structure of high integrity is formed, with the input fibre fixed relative to the scattering structure in the flat optical fibre. Incoming light is therefore always incident on the scattering structure from the same position and direction so that interaction with the scattering structure is consistent over time, and the unique mapping of wavelength to speckle pattern is preserved. Fusion splicing of conventional circular optical fibre to flat optical fibre is facilitated where the diameter of the circular optical fibre is comparable to the thickness of the flat optical fibre. It is therefore proposed that the input optical fibre has a diameter (outer diameter of the cladding) which is in the range of 30% to 200% of the thickness of the flat optical fibre.

Usefully, the input optical fibre comprises single mode optical fibre. This also contributes to the stability of the spectrometer by providing consistent delivery of the incident light to the scattering structure in one known optical mode, so that the scattering effect is repeatable over time, again helping to preserve the unique mapping of wavelength to speckle pattern.

An all-fibre device is also readily integratable into wider optical systems, particularly those employing optical fibres. For example, a variety of optical fibre-based sensors are known which have a variable wavelength output, and a spectrometer as proposed herein can be directly and physically coupled to the fibre sensor for interrogation of the sensor output. This can increase compactness, robustness and stability, and reduce loss of the optical signal output from the sensor.

FIG. 2 shows a simplified schematic plan view of an example device for speckle-based spectrometry as proposed herein. The device 10 is shown looking towards the side face 20 of the flat optical fibre 12 shown in FIG. 1. As before, the flat optical fibre 12 comprises a scattering structure 22 within it, and additionally comprises an input optical fibre 24 in the form of a portion of conventional solid core circular optical fibre. A proximal end of the input optical fibre 24 is joined to the input face 18 of the flat optical fibre 12 by a fusion splice 26. A distal end of the input optical fibre 24 (indicated by dashed lines, since the input optical fibre may have any length which is convenient for the application(s) for which the spectrometer is intended) is able to receive an optical input (from another optical fibre or after free space propagation, for example) comprising light whose wavelength is required to be determined and which therefore is delivered as incident light L for the spectrometer. After propagating along the input optical fibre 24, the incident light L is transmitted across the splice 26 and into the flat optical fibre, where it continues propagation in the forward direction until it is received at the scattering structure 22. The incident light L is then scattered by the scattering centres of the structuring structure 22 to form scattered light S with multiple propagation directions, which interferes to form a speckle pattern.

The geometry of the flat optical fibre also aids stability of the spectrometer. The increased width, compared to conventional circular optical fibre, and generally planar shape provides an increased lateral stiffness, and such fibre is less prone to accidental bending or stretching. As well as increased robustness, this structural stability inhibits distortion of the flat optical fibre caused by external factors such as environmental changes and contact and hence also inhibits distortion of the scattering structure within. Changes in the relative disposition of the scattering centres will modify the speckle pattern so that the wavelength-speckle pattern mapping is disrupted and measurement accuracy and resolution is reduced. The flat optical fibre hence provides resistance to these drawbacks.

The relatively large width of the flat optical fibre also allows the transmitted incident light to diffract over a large angle, which promotes the excitation of multiple optical modes. When incident on the scattering structure, the multiple modes provide an increased number of scattered optical paths compared to a single optical mode, thereby increasing interference and enhancing the speckle pattern. More intensity variation is present in the speckle pattern and the speckle pattern varies more with wavelength, so resolution of the spectrometer is increased. The proposed spectrometer can therefore be regarded as a hybrid speckle-based spectrometry device, in that it makes use of the interference of multiple optical modes, like previously proposed devices using multimode optical fibre but no scattering centres, as well as the interference of scattered light, like previously proposed devices using various scattering media. These two contributions to interference combine to produce enhanced speckle compared to scattering alone, and in a smaller fibre length than is required for good resolution from a multimode fibre device. The scattering structure comprises a plurality of randomly or pseudo-randomly scattering centres (physical features or disruptions to the material of the flat optical fibre that scatter incident light) located within the flat optical fibre. It may take any practical form that can be introduced to the interior of the flat optical fibre. For example, particles of foreign material, such as a metal, in particular gold, may be added to the material from which the flat optical fibre is formed so that the particles become randomly dispersed throughout at least part of the finished flat optical fibre. However, it is considered advantageous to use a controlled replicable technique to deliberately fabricate the scattering centres within the flat optical fibre. In this way, multiple flat optical fibre portions with identical scattering structures can be produced. Since the scattering structures are identical, they will all produce the same speckle patterns for given wavelengths, and there is no need to individually calibrate each spectrometer by recording a calibration set of the speckle patterns corresponding to a plurality of different wavelengths. A single calibration can be performed, and the calibration set utilised with all the spectrometers with that scattering structure.

One technique suitable for forming the scattering structure is to use ultrashort pulses of light. These are directed into the flat optical fibre, and when of an appropriate power, duration, quantity and focal spot size, will form a nanovoid within the fibre material. Each nanovoid is a single scattering centre. Relative movement of the laser beam across the flat optical fibre to apply pulses to a plurality of spaced-apart positions is used to write a two-dimensional array of nanovoids, and repositioning the focus of the laser beam at different depths within the flat optical fibre can be used to write two or more layers of nanovoids, to create a three-dimensional array [3]. A three-dimensional scattering structure increases the available optical path length by folding the scattered optical path multiple times; this enhances the speckle generation by improving the uniqueness of each speckle pattern for a given wavelength, so that resolution is increased.

Speckle generation requires a random distribution of scattering centres. This can be achieved in a deliberately fabricated scattering structure such as a laser-written nanovoid array by using the concept of quasi-randomness. A periodic array is defined, in which the scattering centres are arranged regularly with a defined and constant separation from their neighbours. Then, the positions for all the scattering centre are subjected to a mathematical randomisation process which applies a shift or displacement to each position which is random with respect to direction and/or distance from the original position, up to a maximum possible shift which is less than the separation in the original periodic array. The scattering centres are then formed at each of newly defined, randomised, positions.

A larger number of scattering centres will improve the scattering efficiency (produce more scattering) and increase the overall path length through the scattering structure, so improves the speckle patterns and hence the resolution. As an example, a total number of scattering centres in the range of 100,000 to 10,000,000 may be considered as giving a useful result with a high resolution adequate for many practical purposes. For scattering centres which are individually fabricated, the quantity included might be selected with reference to balancing fabrication time against achieving a higher level of scattering.

In order to deduce wavelength from speckle patterns, it is necessary to detect and process the scatter patterns. This is achieved by use of an optical detector with any ability to discriminate spatial variation in incident optical intensity, such as a camera or two-dimensional array of optical point detectors. Published speckle-based spectrometers of which the inventors are aware all detect the speckle pattern on the opposite side of the scattering structure from which the incoming light to be measured is received at the scattering structure, in other words, the optical detector is aligned with the incident light propagation direction. In the context of the presently described device, this would require the optical detector to be located at the end face of the flat optical fibre opposite to the input face. A drawback with this arrangement is that the optical detector receives the 0th order diffracted light, which can overexpose the speckle pattern and/or saturate the optical detector, making wavelength measurement inaccurate, unreliable or impossible.

The present disclosure proposes a different approach, which is facilitated by the use of flat optical fibre as the substrate for the scattering structure. Light is scattered from the scattering structure in all directions so it is possible to detect speckle patterns at positions away from the incident propagation direction, and hence away from the 0th order diffraction. Accordingly, it is proposed to detect a component of the speckle pattern which is transmitted through a side face of the flat optical fibre. Recall that the side faces are bounded by the length and the width of the flat optical fibre, and are the largest faces of the flat optical fibre. One side face is designated as an output face, and the optical detector is located so as to detect speckle patterns of light emitted from the flat optical fibre through the output face, along a direction substantially orthogonal to the original propagation direction of the incident light. This out-of-plane detection is enabled by the flat geometry of the flat optical fibre. Out-of-plane detection is not feasible with conventional circular optical fibre, since the curved outer surface introduces lensing effects for light emitted from the side of the fibre so that speckle patterns are distorted and more difficult to image accurately onto a detector. The planar side surface of flat optical fibre addresses this problem, and allows direct imaging of the emitted speckle pattern onto a camera or other detector without the need for any intervening additional optical elements (for focussing and other beam shaping). This allows a further reduction in the size of the device, and a reduced number of components gives increased simplicity and improved stability; there is no potential for misalignment of optical imaging elements. Indeed, for maximum reduction in size, it is proposed that the optical detector may be mounted directly onto or against the outer surface of the output face of flat optical fibre, so that there is no free space propagation of the emitted light at all. This is possible owing to the relatively large size of the output face and the large path length provided by the multiple scattering centres; the emitted light is already widely spatially dispersed at the surface of the flat optical fibre so the speckle pattern can be large enough for good resolution at this location. This should be contrasted with the long free space propagation paths required by dispersion-based spectrometers, for example. Attaching or otherwise directly coupling the optical detector to or against the flat optical fibre provides a fixed alignment for the speckle pattern detection, and adds to the stiffness of the flat optical fibre, so that stability and robustness are also increased. However, it is not essential that the optical detector be integrated with the flat optical fibre in this way, and the optical detector may alternatively be spaced apart from the output face. This facilitates maintenance, exchange or replacement of the optical detector and/or the flat optical fibre, if required. A spacing of a few millimetres is operable, and does not greatly increase the overall size of the device. However, large spacings are not excluded and may be appropriate for some applications and in some circumstances. For example, a spacing up to about 10 cm might be used.

In order to maintain alignment of the optical detector with the flat optical fibre in configurations without a direct attachment, a common housing may be provided, in which the optical detector and the flat optical fibre are held or secured in the correct position relative to one another. They may be received in the housing in a spaced apart arrangement, or positioned such that the housing holds the optical detector in contact with the output face of the flat optical fibre. A housing can also protect the optical detector from ambient light. A housing may also be employed with direct attachment designs in order to form a convenient and compact spectrometer with physical protection for the optical detector and the flat optical fibre. The housing can include an aperture through which the input optical fibre passes or via which the input optical fibre can be accessed (such as by an optical fibre connector), in order that light to be measured can directed into the flat optical fibre.

FIG. 3 shows a simplified schematic side view representation of an example spectrometer device. As before, the spectrometer device 10 comprises a flat optical fibre 12 with an internal scattering structure 22, and an input optical fibre 24 coupled to an input face of the flat optical fibre 12 at a splice 26 or other optical join. Incident light L is directed along the input optical fibre 24 for transmission into the flat optical fibre 12 and interaction with the scattering structure 22, to create a speckle pattern SP which is emitted through the output face 20 of the flat optical fibre (speckle patterns of scattered light are formed along other directions but are not shown for clarity). The emitted speckle pattern SP is incident on an optical detector 25 such as a camera coupled directly against the output face 20. The optical detector 25 detects the speckle pattern SP in the usual way, and generates an output signal representing the light intensity distribution of the speckle pattern. The optical detector 25 is connected to a processor 28 (such as a computer microprocessor running suitable software) via a wired connection 26 in order that the output signal may be communicated to the processor 28. The processor is configured to deduce a wavelength of the incident light L from the received speckle pattern. An optional housing 27 as least partially surrounds both the flat optical fibre 12 and the optical detector 25, as described above.

In order for the processor to deduce the spectral characteristic of the incident light, it is necessary, before first use of the spectrometer for wavelength measurement, to carry out a calibration, in order to produce a calibration set of speckle patterns. To do this, a tunable laser light source, or other optical source or sources configured to generate a range of wavelengths, is be coupled to the input fibre 24 in order to provide incident light. The optical source is operated by stepping through at least some of the available wavelengths, preferably at the smallest available increments in order to maximise the calibration set and provide fine resolution, and detecting and recording a speckle pattern for each of the incident wavelengths. The one-to-one mapping of wavelength to speckle pattern for the particular spectrometer is thereby obtained, and provided to the processor. The processor thence has a reference, against which any subsequent detected speckle pattern can be compared or assessed in order to deduce the wavelength of the light which created the subsequent speckle pattern.

Any suitable mathematical, computational, or analytical tool can be used for deducing the wavelength using the calibration set. For example, a simple pattern matching can be performed, where the measured speckle pattern is compared with the calibration patterns until a match or approximate match is found, and the wavelength of the matching calibration speckle pattern is determined to be the incident wavelength under measurement. However, this may be inaccurate owing to the discrete stepped nature of the wavelengths used to obtain the calibration, since an incident wavelength may lie between two steps and not properly match any of the calibration speckle patterns. This can be improved by using as small a calibration wavelength step size as possible. At the cost of computational time, results may be improved by the use of artificial intelligence to deduce the incident wavelength, with the calibration set being provided to the processor as a machine learning set [6]. Since the problem is a matching problem, mathematical correlation techniques may alternatively be used, using machine learning algorithms to reconstruct the originating incident wavelength from the detected speckle pattern via the calibration set. As examples, singular value decomposition may be used to solve the correlation equation, or principal component analysis which can be useful to better distinguish between very small differences in speckle patterns (which might be determined to be the same via simple correlation) which nevertheless may correspond to large differences in wavelength.

Processing of the detected speckle pattern may be implemented to return an absolute value of wavelength, if the spectrometer is used as a wavelength detector. If the spectrometer is used to interrogate an optical sensor which responds by a change in output wavelength to a parameter such as temperature or strain, the calibration may be performed using the sensor to map the parameter directly to the speckle pattern, rather than the intervening wavelength. The sensor can be operated by stepping through values of the relevant parameter, which provides incident light of correspondingly varying wavelength to the spectrometer, and speckle patterns are recorded for each value of the parameter. When the sensor is used for measurements, the processor can then directly return a value of the parameter, rather than wavelength. Alternatively, a separate mapping of parameter value to wavelength value output by the sensor may be used to convert a wavelength value deduced by the processor into a value of the sensed parameter.

The processor may alternatively be configured to identify a change in the detected speckle pattern, rather than for determining an absolute value of an underlying parameter (wavelength or otherwise). This may be useful if the spectrometer is used for monitoring rather than measurement. The incident light may originate from some light emitting element that can shift wavelength, or from an optical sensor that produces a light output with a wavelength that depends on the parameter to which the optical sensor is configured to be sensitive. Any shift in the wavelength of the incident light will cause a change in the detected speckle pattern, and the processor can identify that a change has occurred and report this as a change in the monitored emitted light or parameter. Calibration of the spectrometer may not be required for basic monitoring applications; the processor can instead carry out simple image processing to recognise an alteration in the speckle pattern. Calibration can allow a magnitude of the wavelength shift or change to be determined, however, in addition to or instead of mere recognition that a change has occurred.

Overall, the processor can be considered to deduce or identify a wavelength characteristic of the incident light, where the characteristic may be an absolute value of wavelength, or a shift in the value of the wavelength. In some cases, the value of the wavelength corresponds to, reflects or indicates a different parameter, in circumstances where the spectrometer is used in conjunction with an optical sensor.

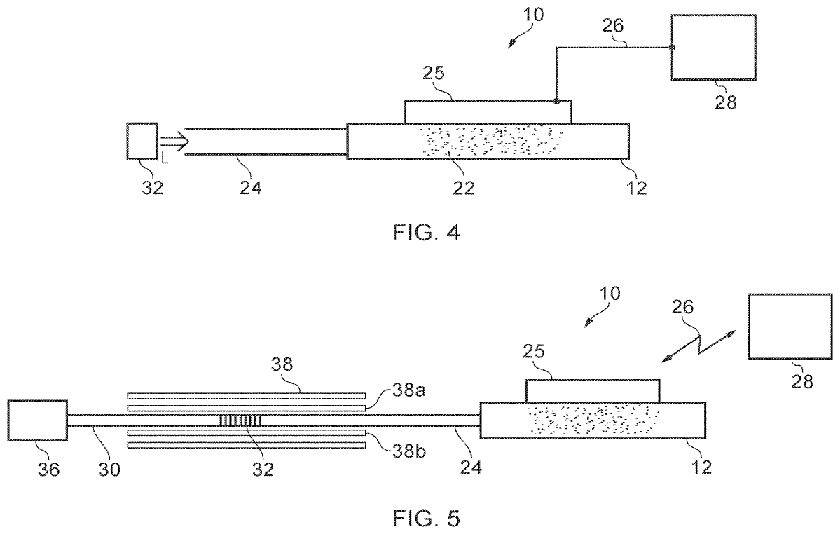

FIG. 4 shows a simplified schematic representation of an example of a sensor system that utilises a speckle-based spectrometer as proposed herein. As has been previously described, the spectrometer 10 comprises a flat optical fibre 12 with an internal scattering structure 22, and an input optical fibre 24 coupled to the input face of the flat optical fibre 12, with a camera or other optical sensor 25 abutted against the output face of the flat optical fibre 12. A processor 28 receives the output signal of the camera 25, in this example via a wired connection 26, or alternatively a wireless connection which can allow the spectrometer 10 to be deployed remotely. Alternatively, the camera 25 may be configured to record and store detected speckle patterns which can be retrieved from the camera 25 for processing at a later time.

The sensor system also comprises an optical sensor 32, being a sensor configured to give an optical output L (light beam) with a wavelength which varies depending on a value of parameter which the sensor is configured to detect. The optical output L of the optical sensor 32 is delivered into the input optical fibre 24 to be transmitted as incident light to the scattering structure 22 in the flat optical fibre 12, in order to create a speckle pattern for detection by the camera 25, as discussed above.

The optical sensor 32 is shown highly schematically and may comprise any optical sensor with a wavelength-varying output. The optical output L may be emitted from the optical sensor 32 into free space and collecting by a lens or other optical element (not shown) for efficient coupling into the input optical fibre 24. Alternatively, the optical sensor 32 may emit its output directly into an optical fibre, which may be the input optical fibre 24, or may be a further optical fibre which is coupled to the input optical fibre 24. Since the spectrometer 10 is an optical fibre-based device, it is highly practical for use with sensors configured to deliver an output directly into optical fibre, and the sensor may be permanently integrated with the input optical fibre 24. In particular, optical sensors implemented inside optical fibre are well suited. An example is a fibre Bragg grating (FBG), which comprises a periodic variation of refractive index along the core of an optical fibre, and has a spectral response such that it reflects and transmits incident light at wavelengths depending on the size and pitch of the refractive index variation. When the FBG is distorted, for example if the optical fibre expands or contracts in length, the grating period is altered, and the spectral response changes. Detection of reflected or transmitted light received from a FBG can therefore be used to measure or monitor an external parameter that causes a change in the grating length. Commonly, FBGs are used to sense temperature and strain.

Therefore, a sensing system can comprise one or more FBGs as the optical sensor 32, where the FBG is defined in an optical fibre which is optically coupled to the input fibre 24 of the spectrometer 10. In a very simple case, the FBG can be defined in the input optical fibre 24 itself. Otherwise, the FBG can be defined in a further optical fibre which is coupled to the input optical fibre by a splice or other coupling arrangement. The arrangement may be such that the FBG is used in transmission, so that light from an optical source (not shown) is directed along the fibre containing the FBG, and a portion of the light which is transmitted through the FBG becomes the incident light for the spectrometer. A single optical fibre or a span of two or more connected optical fibres coupled between the optical source and the flat optical fibre, and containing the FBG, could be used, although more complicated optical circuits may be employed. Alternatively, the FBG may be used in reflection, so that the portion of light reflected from the FBG is delivered to the spectrometer. An optical circulator can be used to direct light to the FBG and then redirect the reflected light to the input optical fibre.

FIG. 5 shows a simplified schematic representation of a further example sensor system using the proposed speckle-based spectrometry approach. As noted above, FBG sensors can be utilised to measure or monitor strain. If the optical fibre containing the FBG is secured to a component or other element, movement, flexing or stretching of the component arising from strain in the component will cause distortion of the FBG, producing a change in the spectral response which can be detected with a spectrometer. An application of particular interest in the field of strain sensing is the monitoring of strain in composite laminated materials comprising multiple layers or plies of material laminated together, and in components made from such composite materials. Monitoring of the structural health of such materials is important since damage or separation of the ply layers can cause material and component failure. Owing to the small size of optical fibres, FBG sensors can be embedded within the layers of a composite material to allow strain monitoring during material fabrication and/or over the lifetime of a component made from the material. FBGs in flat optical fibres are useful for this, since they can be embedded with less disruption to the ply structure [7]. The FBG requires interrogation, however, so it is proposed that a spectrometer as proposed herein may be used; the compact size, stable operation and robust structure make these spectrometers feasible for use in a wide range of conditions, and feasible to integrate into or onto a component.

FIG. 5 shows a spectrometer as previously described, comprising a flat optical fibre 12 with a scattering structure and an input fibre 24, plus a camera 25 for capturing speckle patterns which is configured to send its output signals via a wireless connection 26 to a processor 28 (or data store to save for later processing). A FBG sensor 32 is located in the core of an optical fibre 30 which is coupled to the input fibre 24, or may comprise the input fibre 24, and has an associated optical source 36 configured to emit light into the optical fibre 30 for interaction with the FBG 32. The FBG 32 is shown as operating in transmission, so that light from the optical source passes through the FBG 32 to reach the spectrometer 10, but a reflection arrangement could be used instead. The FBG 32 is embedded in an item or component 38 formed from composite laminated material, by the optical fibre 30 housing the FBG 32 being sandwiched between two plies 38a, 38b of the composite material. For simplicity, the optical fibre 30 is shown with its two ends, one coupled to the optical source 36 and one coupled to the spectrometer 10, extending out of the sides of the component 38, with the optical source 36 and the spectrometer 10 separate from the component 38. However, the optical source 36 and/or the spectrometer 10 can be mounted on the composite material, or on an adjacent element of the component, and the optical fibre 30 can be channelled through the ply layers to the surface of the composite material in order to couple with the optical source 36 and the spectrometer 10 if they are mounted there.

Other optical sensors implemented in optical fibre may similarly be embedded between ply layers of a composite laminated material for the sensing/detection/measurement of strain or other parameters of interest within the material or to which the material or a component or item made from the material is subjected or exposed.

A experimental example of a spectrometer as proposed herein and its operation in conjunction with a FBG strain sensor will now be described.

A flat optical fibre was fabricated from a quartz preform having a thickness of 2 mm and a width of 30 mm by heating the preform in a furnace and drawing it using a temperature, preform feed rate and fibre draw rate suitable to draw the preform down to a fibre with a thickness of the order of 100 μm and a width of 1 mm (noting that the aspect ratio of the finished fibre is reduced from that of the preform owing to surface tension effects in the softened material. The flat optical fibre had no core, and a portion of 1.3 cm length was taken to be made into a spectrometer. A single mode input optical fibre was fusion spliced to an end face of the flat optical fibre.

Next, a scattering structure was formed inside the flat optical fibre, by writing nanovoids into the fibre material using ultrashort pulses of laser light of wavelength 515 nm, pulse duration 200 fs and repetition rate 200 kHz. The scattering structure was a three-dimensional array of nanovoids, arranged in 15 planes separated by 6.6 μm. Each plane measured 1 mm by 0.7 mm and comprised 714 by 500 voids with a mean separation of 1.4 μm and a random shift of alignment from a constant separation in the range of +0.7 μm to give a quasi-random distribution of scattering centres.

A housing was made by 3D printing, in order to block ambient light, protect the flat optical fibre and align and fix the flat optical fibre and a camera in appropriate relative positions. When placed in the housing the camera (with its lens removed) was spaced 2 mm from the output face of the flat optical fibre. A control chip for the camera was mounted on the outside of the housing, and the resulting device weighed 100 g and measured 2.5×2.5×1.5 cm. When calibrated and used to interrogate a FBG strain sensor, good repeatability and device stability was demonstrated.

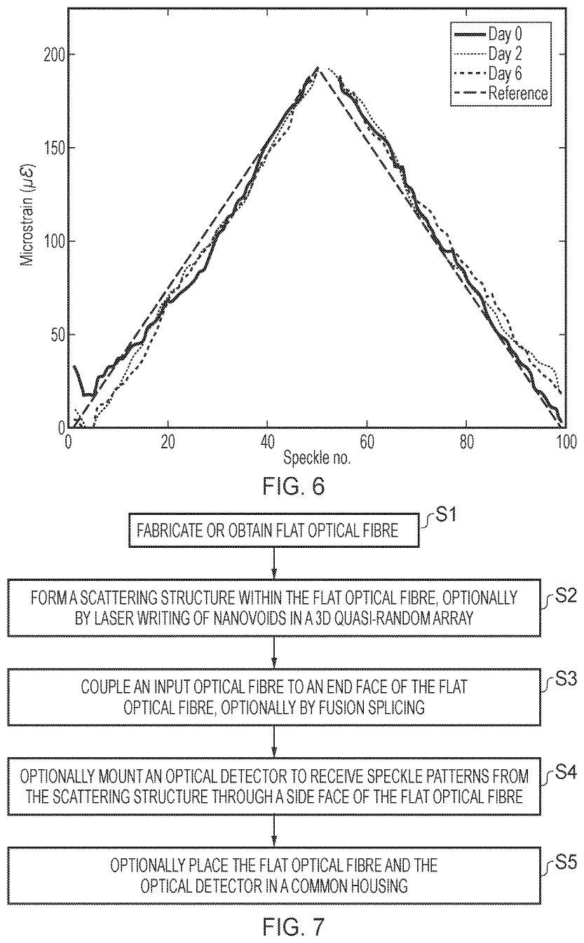

FIG. 6 shows a graph of speckle pattern (identified by number) against the corresponding microstrain induced in the FBG sensor that produced each pattern. The dashed line shows reference data obtained to calibrate the spectrometer, and the solid, dotted and dashed-dotted lines respectively show later test data recorded for the same values of induced microstrain on Day 0, Day 2 and Day 6. A high level of correlation was found between the speckle patterns generated in the later measurements and the speckle patterns from the reference data, indicating good long term stability such that reliable operation from the spectrometer can be anticipated. Sub-picometre spectral resolution was observed.

FIG. 7 shows a flow chart of steps in an example method of fabricating a spectrometer according to examples described herein. In a first step S1, a flat optical fibre is obtain, such as by fabricating by drawing from a preform as described above. In a second step S2, a scattering structure is formed inside the flat optical fibre. This may be done by creating a quasi-random array (2D or 3D) of nanovoids within the fibre material, by writing with ultrashort laser pulses, as described above. In a third step S3, an input optical fibre is coupled to an end face (input face) of the flat optical fibre, such as by fusion splicing as described above. The spectrometer may be provided to a user in this format for the user to use in conjunction with their own optical detector. Alternatively, the method may proceed to optional step S4, in which an optical detector is mounted so as to detect speckle patterns generated from the scattering structure and emitted through a side face (output face) of the flat optical fibre, as described above. In a final optional step S5, the flat optical fibre and the optical detector may be placed in a common housing, also as described above.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

### REFERENCES

[1] WO 2015/063481
[2] B Redding et al, “Compact spectrometer based on a disordered photonic chip”, Nat. Photonics, vol.7, 746-751, 2013
[3] PL Falak et al, “Femtosecond laser written scattering chip for high-resolution low-cost reconstructive spectrometry”, Photonic Instrumentation Engineering IX vol. 12008, 120080E, DOI: 10.1117/12.2608748, SPIE, 2022
[4] WO 2013/188520
[5] Tianliang Wang et al. “Deep-learning assisted fiber Bragg grating interrogation by random speckles”, Opt. Lett. vol. 46. 5711-5714, 2021
[6] R Hamid et al, “Use of machine learning in a speckle-based optical fiber sensor for temperature detection”, AI and Optical Data Sciences III, vol. 120129, 128-134, 2022.
[7] US 2022/0260363

1. A spectrometer comprising:
a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length;
an input optical fibre optically coupled to the input face to transmit incident light into the flat optical fibre along the propagation direction; and
a scattering structure within the flat optical fibre configured to receive and scatter the incident light to create a speckle pattern via interference of the scattered incident light, a component of the speckle pattern being emitted for detection from the flat optical fibre through the output face along a direction orthogonal to the propagation direction.

2. A spectrometer according to claim 1, further comprising an optical detector arranged to receive and detect the speckle pattern emitted from the output face.

3. A spectrometer according to claim 2, wherein the optical detector is arranged to receive the speckle pattern directly from the output face without intervening optical elements.

4. A spectrometer according to claim 3, wherein the optical detector is arranged directly against the output face.

5. A spectrometer according to claim 2, further comprising a housing in which the flat optical fibre and the optical detector are received.

6. A spectrometer according to claim 1, wherein the input optical fibre comprises a single mode optical fibre with a substantially circular cross-section.

7. A spectrometer according to claim 1, wherein the input optical fibre is fusion spliced to the input face.

8. A spectrometer according to claim 1, wherein the flat optical fibre does not have a waveguiding core.

9. A spectrometer according to claim 1, wherein the flat optical fibre has a waveguiding core extending along the propagation direction.

10. A spectrometer according to claim 1, wherein the flat optical fibre is configured for multimode optical waveguiding.

11. A spectrometer according to claim 1, wherein the width of the flat optical fibre is at least three times the thickness of the flat optical fibre.

12. A spectrometer according to claim 1, wherein the scattering structure comprises a three-dimensional array of pseudo-randomly positioned scattering centres.

13. A spectrometer according to claim 12, wherein the scattering centres comprise nanovoids written into the flat optical fibre by ultrashort pulses of laser light.

14. A spectrometer according to claim 1, further comprising a processor configured to receive an output signal representing a detected speckle pattern from the optical detector and deduce a spectral characteristic of the incident light from the detected speckle pattern.

15. A spectrometer according to claim 14, wherein the processor is configured to deduce the spectral characteristic of the incident light from the detected speckle pattern using machine learning algorithms.

16. A spectrometer according to claim 14, wherein the processor is configured to deduce the spectral characteristic of the incident light from the detected speckle pattern using a mathematical correlation technique.

17. A sensor system comprising:
a spectrometer according to claim 1; and
at least one sensor configured to generate an optical output with a variable spectral characteristic to be transmitted as the incident light into the flat optical fibre by the input optical fibre.

18. A sensor system according to claim 17, wherein the at least one sensor comprises one or more fibre Bragg gratings defined within a core of the input optical fibre or within a core of a further optical fibre coupled to the input optical fibre.

19. An item formed from a laminated material comprising two or more ply layers, and comprising:
a sensor system according to claim 17, wherein the at least one sensor is embedded between adjacent ply layers of the laminated material to operate as a sensor or sensors for measuring strain in the component.

20. A component for a spectrometer comprising:
a flat optical fibre having a length along a propagation direction for light input into the flat optical fibre, a width orthogonal to the length, a thickness less than the width and orthogonal to the length and the width, an input face bounded by the width and the thickness, and an output face bounded by the width and the length, the input face configured to be coupled to an input optical fibre for transmitting incident light into the flat optical fibre along a propagation direction; and
a scattering structure within the flat optical fibre configured to receive and scatter the incident light to create a speckle pattern via interference of the scattered incident light, a component of the speckle pattern being emitted for detection from the flat optical fibre through the output face along a direction orthogonal to the propagation direction.

21-24. (canceled)
